(19) United States
(12) Patent Application Publication
(10) Pub. No.: US 2014/0303905 A1
(43) Pub. Date: Oct. 9, 2014

(54) SYSTEM AND METHOD FOR QUANTIFYING CORRELATION BETWEEN ROAD SURFACE PROFILE AND ROAD NOISE

(71) Applicant: Hyundai Motor Company, Seoul (KR)

(72) Inventors: Ki Chang Jo, Hwaseong-si (KR); Hong Sun Baik, Suwon-si (KR); Dong Wook Jung, Hwaseong-si (KR); Dong Ju Yoon, Hwaseong-si (KR); Jae Joon Seo, Hwaseong-si (KR); Ki Soo Yoon, Suwon-si (KR)

(73) Assignee: Hyundai Motor Company, Seoul (KR)

(21) Appl. No.: 14/057,895

(22) Filed: Oct. 18, 2013

(30) Foreign Application Priority Data
Apr. 5, 2013 (KR) 10-2013-0037745

(51) Int. Cl. G01H 1/00

(52) U.S. Cl. CPC G01H 1/00
USPC 702/33

(57) ABSTRACT

A system and method quantifies correlation between a road surface profile and road noise. The profile and interior noise and a running speed of a vehicle are simultaneously measured in real time, and by using measurement information, correlation between the profile and the road noise is quantitatively objectified. The profile is measured in real time and, at the same time, interior noise and running speed are measured. Data of the profile is converted into a displacement-based signal using the running speed data. An error component corresponding to a distance frequency that cooperates with the profile is removed by using the measured running speed data. A mean profile depth (MPD) is calculated by using the profile data. Road noise is measured from the interior noise data. And MPD is matched with the road noise to generate a correlation graph.

### CROSS-REFERENCE TO RELATED APPLICATION

The present application claims priority of Korean Patent Application Number 10-2013-0037745 filed Apr. 5, 2013, the entire contents of which application is incorporated herein for all purposes by this reference.

### BACKGROUND OF INVENTION

1. Field of Invention

The present disclosure relates to a system and method for quantifying correlation between a road surface profile and road noise, and more particularly, to a system and method for quantifying correlation between a road surface profile and road noise, in which on a real road on which a vehicle is running, a road surface profile and interior noise and a running speed of the vehicle are simultaneously measured in real time, and by using measurement information, correlation between the road surface profile and the road noise for the real road is quantitatively objectified.

2. Description of Related Art

Generally, out of noise generated during running of a vehicle, noise generated by a road surface profile that works as an excitation force on a tire is referred to as “road noise”.

Conventionally, to measure a road surface profile in terms of road noise, a coin or a familiar object and a road surface particle are visually (based on pictures thereof) compared in size with each other.

Such a conventional method broadly recognizes road surface's roughness based on pictures, failing to quantify or objectify the road surface profile and thus to quantitatively expressing correlation between the road surface profile and road noise.

When necessary, a laser scanner or a patch may be used to measure a road surface profile, but this method requires significant time and cost because of measuring the road surface profile during a stop state of a vehicle, and even may be accompanied by danger.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Accordingly, various aspects of the present invention has been made to solve the foregoing problem, and provides a system and method for quantifying correlation between a road surface profile and road noise, in which on a real road on which a vehicle is running, a road surface profile and interior noise and running speed of the vehicle are simultaneously measured in real time, and by using information such as the measured road surface profile, interior noise, and running speed, correlation between the road surface profile and the road noise for the real road may be quantitatively objectified.

According to various aspects of the present invention, there is provided a system for quantifying correlation between a road surface profile and road noise. The system includes a road surface profile measuring unit for measuring the road surface profile of a road to provide road surface profile data, a noise measuring unit for measuring interior noise of a vehicle to provide noise data, a vibration measuring unit for measuring body vibration of the vehicle to provide vibration data, an electronic control unit (ECU) for obtaining running data through controller area network (CAN) communication, a global positioning system (GPS) receiver for obtaining running route information on an electronic map by cooperating with a GPS satellite, and a system main body for calculating a mean profile depth (MPD) by using the road surface profile data and matching the calculated MPD with road noise measured from the noise data based on measurement time to generate a correlation graph.

According to various aspects of the present invention, there is provided a method for quantifying correlation between a road surface profile and road noise. The method includes a first step of measuring a road surface profile of a road in real time during running of a vehicle and at the same time, measuring interior noise of the vehicle and running speed of the vehicle, a second step of converting data of the road surface profile into a displacement-based signal by using the measured running speed data, a third step of removing an error component corresponding to a distance frequency that cooperates with the road surface profile, by using the measured running speed data, a fourth step of calculating a mean profile depth (MPD) by using the road surface profile data from which the error component is removed in the third step, a fifth step of measuring road noise from the interior noise data, and a sixth step of matching the MPD with the road noise to generate a correlation graph.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating an exemplary system for quantifying correlation between a road noise profile and road noise according to the present invention;

FIG. 2 illustrates a correlation graph between a road surface profile and road noise obtained by an exemplary system and method according to the present invention;

FIG. 3 is a flowchart schematically illustrating a method for quantifying correlation between a road noise profile and road noise according to the present invention;

FIG. 4 illustrates a table showing data obtained to check correlation between a road surface profile and road noise; and

FIG. 5 illustrates a graph of correlation between a mean profile depth (MPD) and road noise shown using data of FIG. 4.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

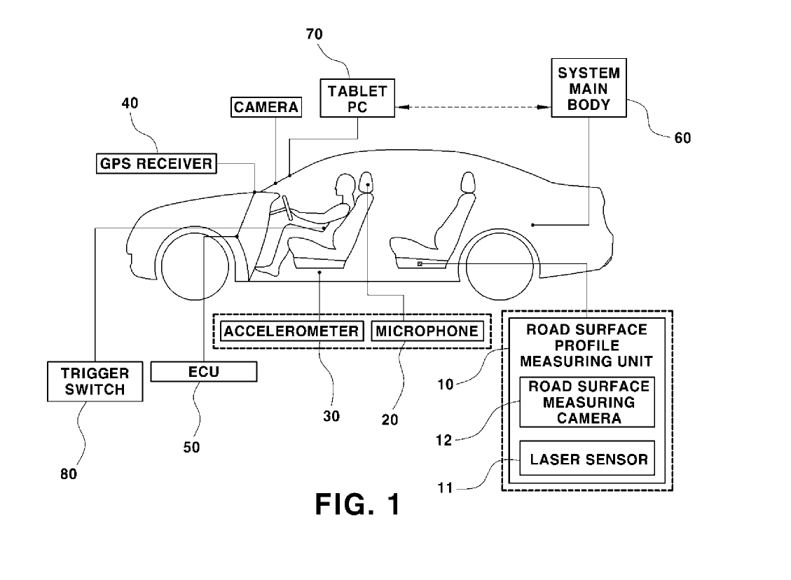

As illustrated in FIG. 1, a system for quantifying correlation between a road surface profile and road noise according to the present invention may include a road surface profile measuring unit 10, a noise measuring unit 20, a vibration measuring unit 30, a global positioning system (GPS) receiver 40, an electronic control unit (ECU) 50, a system main body (including a storing unit) 60, a display unit 70, and an input unit 80, and all of them are mounted on a vehicle.

The road surface profile measuring unit 10 is intended to measure a road surface profile on a real road and includes a laser displacement sensor 11 and a road surface measuring camera 12.

The laser displacement sensor 11 is a laser sensor for measuring displacement by using a laser. The laser displacement sensor 11, when mounted on the vehicle, is installed on an exterior of the vehicle toward the ground, and records a road surface profile by measuring a distance from the sensor to the ground.

The wavelength of the road surface profile which affects road noise is usually 1 mm-100 mm. Thus, to measure the road surface profile without disturbing the traffic during running of the vehicle, a laser displacement sensor having a high sampling frequency needs to be used. For example, when the vehicle runs at 36 kph, the proper sampling frequency of the laser displacement sensor is 10 kHz.

The present invention uses a laser displacement sensor having a sampling frequency of 30 kHz and this laser displacement sensor may measure a road surface profile even when a vehicle runs at up to 108 kph.

The road surface measuring camera 12, when mounted on the vehicle, is also installed on the exterior of the vehicle toward the ground to record the road surface state as an image, such that the measured road surface state (seams, irregularities, and so forth) may be visually (with naked eyes) checked.

The road noise profile measuring unit 10 is operable in the running vehicle, and may safely and easily measure the road noise profile on the real road on which the vehicle is running, without disturbing running of the vehicle.

The noise measuring unit 20 is a sensor that is mounted in an interior of the vehicle to measure interior noise of the vehicle, and includes a microphone or the like.

The microphone is attached in a position corresponding to the height of an ear of a passenger who sits on a front seat (for example, a seat's headrest) and a center portion of a back seat to measure interior noise.

The vibration measuring unit 30 is a sensor that is mounted on both rails of a driver seat of the vehicle to body vibration of the running vehicle, and includes an accelerometer. Since an acceleration is usually measured to analyze vibration characteristics of the vehicle, an accelerometer is used as the vibration measuring unit 30.

The GPS receiver 40 stores information received from a GPS satellite in a system main body 60 and expresses a vehicle's running route on an electronic map, and when necessary, the GPS receiver 40 may also measure vehicle speed.

That is, the GPS receiver 40 may obtain running route information on an electronic map (e.g., a Google map, etc.) by cooperating with a GPS satellite. The running route information may include location information of the vehicle, time information, traffic information, and so forth.

The ECU 50 is a device for controlling and managing various information related to a vehicle's running speed, an engine RPM, an acceleration positioning sensor (APS), a throttle positioning sensor (TPS), and so forth, and through a controller area network (CAN), obtains running data (CAN data).

The ECU 50 transfers the vehicle's CAN data to the system main body 60 through a connector which then forwards the CAN data to the system main body 60 through a vehicle's on board diagnostics (OBD) terminal.

The system main body 60 includes the ECU 50 that is a processor such as a computer to control the overall operation of the vehicle, collects real-time noise/vibration/harshness (NVH) and vehicle running data by cooperating with the measuring units 10, 20, and 30 and the GPS receiver 40, and includes a storing unit for storing the collected data.

The storing unit is a storage medium included in the system main body 60 and has a capacity of 128 Gbyte (1 Gbyte/1 hour) or more.

The system main body 60 matches the CAN data, the road surface profile data, the vibration data, and the noise data with the vehicle running route information and stores them in the storing unit.

The system main body 60 also matches the real-time simultaneously measured road surface profile data and noise data and the vibration data based on measurement time, and stores them in the storing unit.

The system main body 60 is provided in the form of a black box in the trunk of the vehicle to perform overall management of the system, and also serves as a data logger that stores measurement data received from the road surface profile measuring unit 10, the noise measuring unit 20, the vibration measuring unit 30, the GPS receiver 40, and the ECU 50.

For example, the system main body 60 receives data from the vibration measuring unit 30 and the noise measuring unit 20 through 4 channels and in this case, the sampling frequency is 100 Hz.

The system main body 60 may receive not only the CAN data provided from the ECU 50, but also various data such as data in the form of an analog signal provided from the accelerometer, data in the form of a digital (pulse) signal provided from the microphone, and data provided from a mobile storage means such as a universal serial bus (USB).

The analog data is measured through 8 channels and the digital data is measured through 2 channels.

The system main body 60 calculates a mean profile depth (MPD) by using the road surface profile data input from the road surface profile measuring unit 10, particularly, the laser displacement sensor 11, and expresses the calculated MPD on a graph together with noise data (vehicle's interior noise) measured at the same time as the MPD to show correlation between them with a correlation graph.

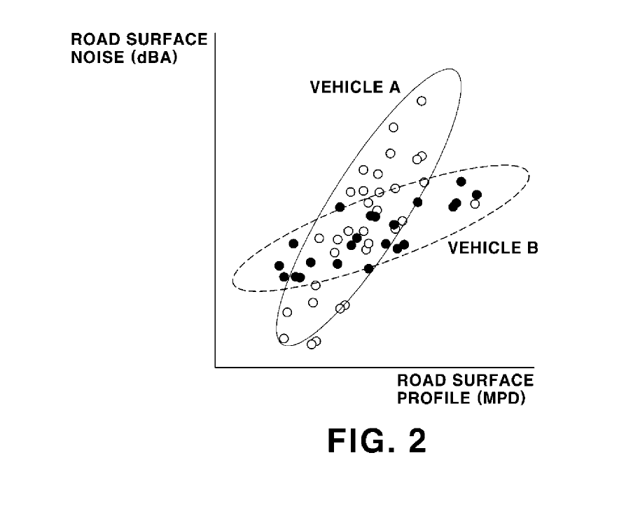

The obtained correlation graph quantitatively objectifies correlation between the road surface profile and the road noise, and is plotted, for example, as illustrated in FIG. 2.

The system main body 60 matches the measured MPD and noise data based on measurement time to generate a correlation graph.

The system main body 60 transmits the obtained correlation graph to the display unit 70 to allow a user to monitor it.

The display unit 70 is an output device for allowing the user to monitor the NVH and the vehicle running data in real time, and outputs the correlation graph generated in the system main body 60 to allow the user to visually check the correlation graph. The display unit 70 may use a tablet PC or the like.

The input unit 80 is a trigger switch which turns on/off the power of the system main body 60 and data recording, and is provided in a position that is easy to hold by the driver, such that the driver may simply manipulate the system during driving.

The input unit 80 may receive a user's input for executing a pre-trigger function and a marking function of the system main body 60.

The pre-trigger function stores the road surface profile data, the noise data, the vibration data, the running route information, and the CAN data in the storing unit of the system main body 60 from a predetermined time before ON of the data record switch of the input unit 80.

The marking function checks important data by a user's selection (input) among data recorded in the storing unit of the system main body 60.

Once the system main body 60 is powered on, it collects data without a separate input thereto, shows some of the collected data to the user through the display unit 70, and stores the collected data simultaneously with ON of the data record switch of the input unit 80.

Hereinafter, a process of quantifying correlation between a road surface profile and road noise by using the system according to the present invention will be described.

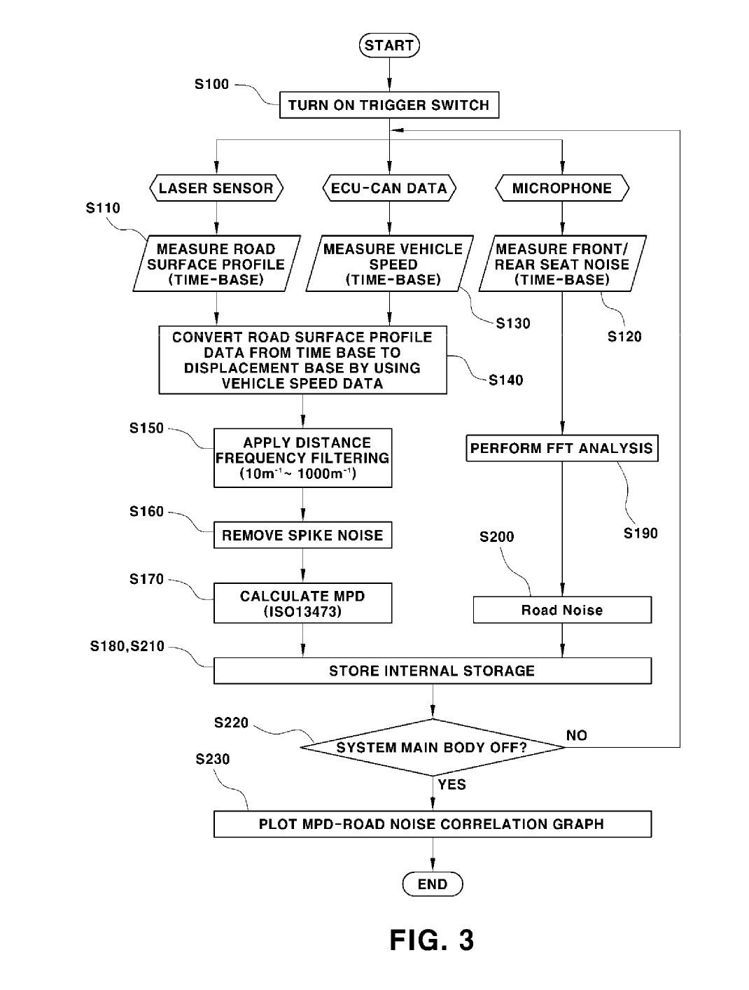

FIG. 3 shows a process of quantifying correlation between a road surface profile and road noise according to the present invention.

As illustrated in FIG. 3, the system main body 60 is first operated through the input unit 80 in step S100.

Simultaneously with the operating of the system main body 60, the laser displacement sensor 11 measures the road surface profile of the real road on which the vehicle is running in step S110, and the noise measuring unit 20 measures interior noise in front/rear seats of the running vehicle in step S120, and the ECU 50 obtains running speed data through CAN communication in step S130.

The data such as the road surface profile, the interior noise, and the running speed all are measured as time-base signals based on time.

The road surface profile data includes behavior/vibration components of the vehicle, together with a road surface profile component.

Therefore, the actual road surface profile may be obtained by removing a vertical vibration component of the vehicle from a measurement value of the laser displacement sensor 11.

When receiving the road surface profile data from the laser displacement sensor 11, the system main body 60 removes a body vibration component included in the road surface profile data.

That is, the laser displacement sensor 11 is installed in the vehicle body and thus is affected by the behavior of the running vehicle, such that the vehicle body vibration data measured by the vibration measuring unit 30 is subtracted to cancel an error.

The vibration measuring unit 40 includes an accelerometer, and the system main body 60 converts the input measurement value of the vibration measuring unit 30 into a displacement value corresponding to the road surface profile and subtracts the displacement value from the road surface profile data of the laser displacement sensor 11, thus correcting an error of the laser displacement sensor 11 caused by vibration of the vehicle body.

That is, by subtracting the measurement value of the vibration measuring unit 30 from the road surface profile data, the profile data of the actual road surface from which the vehicle's vibration component is removed may be obtained.

The system main body 60 obtains a signal in which an error component of the road surface profile data is removed from the road surface profile data, by using vibration data (vehicle body vibration information) measured by the vibration measuring unit 30, and converts the road surface profile data based on time into a displacement-base signal based on displacement by using the running speed data received from the ECU 50 in step S140.

The system main body 60 then removes an error and noise corresponding to the vehicle's behavior from the road surface profile converted into the displacement-base signal by filtering a component corresponding to a distance frequency cooperating with the running speed, in step S150.

A distance frequency of the road surface profile which affects the road noise is 10-1000 m⁻¹, such that by filtering a component excluding the affecting distance frequency, an error and noise corresponding to the vehicle's behavior may be removed from the road surface profile data.

In this case, the distance frequency for filtering is measured in cooperation with the real-time measured vehicle running speed, and the running speed uses the CAN data of the ECU 50 or the data of the GPS receiver 40.

For example, when the vehicle runs at 60 kph, the filtering frequency includes a high-pass frequency of 167 Hz and a low-pass frequency of 1667 Hz.

That is, when the vehicle runs at 60 kph, the system main body 60 filters data corresponding to 167 Hz or lower and data corresponding to 1667 Hz or higher out of the road surface profile data, thus removing an error and noise corresponding to the vehicle's behavior.

When the vehicle runs on a flat road surface, i.e., on a smooth road, the vehicle's behavior rarely affects data of the laser displacement sensor 11. Thus, when the vehicle's behavior is not large, the error of the laser displacement sensor 11 corresponding to the vehicle's behavior may be corrected merely with distance frequency filtering.

The system main body 60 also removes spike noise from road surface profile data from which the error and noise are removed, before calculating an MPD, in step S160.

The system main body 60 determines data corresponding to a preset value out of the road surface profile data as the spike noise, and calculates the MPD only for the road surface profile data excluding the corresponding data.

For example, the system main body 60 compares a peak value of each pulse of the road surface profile data with its preceding or following pulse, such that if the peak value of the pulse is two times or more larger than one or more of the preceding and following pulses, the system main body 60 determines the pulse as spike noise and excludes the pulse in MPD calculation.

The system main body 60 calculates the MPD by using the road surface profile data from which the error and noise are removed through the foregoing process in step S170.

The MPD is a parameter that indicates a mean depth on the straight line of the road surface, and is calculated as a quantitative value of the road surface profile by the system main body 60.

As is known, the MPD may be calculated based on ISO 13473 by using:

$$M P D = \frac{{H}_{1} + {H}_{2}}{2} {H}_{ave} \qquad Eq . 1$$

wherein H₁ indicates a maximum height value of a front part of two parts into which the road surface profile data used for calculation of the MPD is divided (that is, a maximum value of the front part of the road surface profile data), H₂ indicates a maximum height value of a rear part of the two parts of the road surface profile data used for calculation of the MPD (that is, a maximum value of the rear part of the road surface profile data), and Hₐᵥₑ indicates an average height value of the road surface profile data used for calculation of the MPD (that is, an average value of the road surface profile data).

The system main body 60 stores the calculated MPD in the storing unit of the system main body 60 in step S180.

Also, as is known, the MPD has correlation with road noise, and this road noise is measured from the vehicle's interior noise which is measured simultaneously with the real-time measurement of the road surface profile and the running speed.

The system main body 60 performs frequency analysis (FFT) with respect to the vehicle interior noise input from the noise measuring unit 20 in step S190 to measure the road noise in step S200 and store the measured road noise in the storing unit in step S210.

The foregoing process is repeated with respect to various roads to secure various MPD and road noise data.

That is, if an off signal is not input to the input unit 80, the system main body 60 operates the laser displacement sensor 11, the noise measuring unit 20, the vibration measuring unit 30, the GPS receiver 40, and the ECU 50 to repeat the foregoing process, thus securing MPD and road noise data with respect to various roads.

If the off signal is input through the input unit 80 in step S220, the system main body 60 stops measuring and recording MPD and road noise data and matches MPD data with road noise data stored in the storing unit to plot a correlation graph between them in step S230.

That is, the system main body 60 matches MPD data with road noise data according to road surface profile data and vehicle interior noise data which are simultaneously measured in real time, thus showing a correlation graph.

The system main body 60 transmits the generated correlation graph to the display unit 70 to allow the user to monitor the correlation graph through the display unit 70.

By generating the correlation graph between the MPD data and the road noise data in this way, a graph which quantifies correlation between the MPD data and the road noise data may be obtained as illustrated in FIG. 2.

Generally, an MPD is measured for several tens of sections for each road/road surface, and an average value of multiple MPDs is used as an MPD of the corresponding road/road surface.

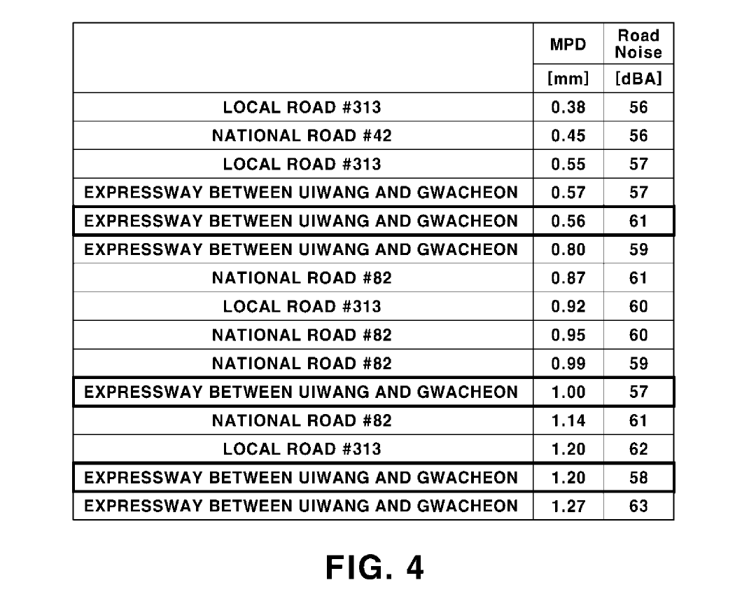

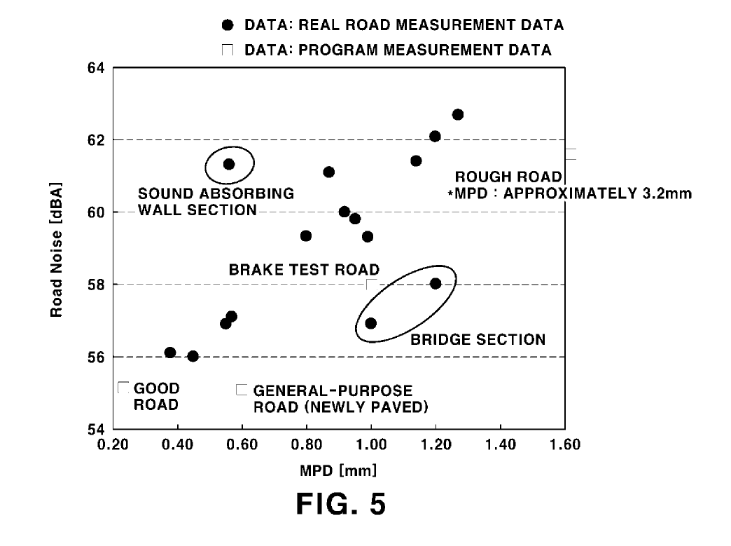

Meanwhile, to check correlation between an MPD and road noise, as illustrated in FIG. 4, for a vehicle that runs at 60 kph on an asphalt road, road noise and MPD data corresponding to a road surface profile and vehicle interior noise are secured and matched to each other, thus plotting a correlation graph as illustrated in FIG. 5.

As a result, as illustrated in FIG. 5, except for special sections such as a sound absorbing wall section in which a sound absorbing wall is installed or a bridge section in which a bridge is installed, correlation between a MPD and road noise on a general road surface section may be identified.

The system and method for quantifying correlation between a road surface profile and road noise according to the present invention simultaneously measure a road surface profile and interior noise and running speed of the vehicle in real time, thus quantitatively objectifying correlation between the road surface profile and the road noise and thus predicting road noise corresponding to a particular road surface.

Moreover, according to the present invention, the road surface profile may be easily measured without disturbing the traffic on an actual road on which the vehicle is running.

For convenience in explanation and accurate definition in the appended claims, the terms front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for quantifying correlation between a road surface profile and road noise, the system comprising:
a road surface profile measuring unit for measuring the road surface profile of a road to provide road surface profile data;
a noise measuring unit for measuring interior noise of a vehicle to provide noise data;
a vibration measuring unit for measuring body vibration of the vehicle to provide vibration data;
an electronic control unit (ECU) for obtaining running data through a controller area network (CAN);
a global positioning system (GPS) receiver for obtaining running route information on an electronic map by cooperating with a GPS satellite; and
a system main body for calculating a mean profile depth (MPD) by using the road surface profile data and matching the calculated MPD with road noise measured from the noise data based on measurement time to generate a correlation graph.

2. The system of claim 1, further comprising:
an input unit for turning on/off power and data recording of the system main body; and
a display unit for outputting the correlation graph generated by the system main body to allow a user to visually check the correlation graph.

3. The system of claim 1, wherein the system main body comprises a storing unit for storing data therein and matches the road surface profile data, the running data, the noise data, and the vibration data that are simultaneously measured in real time with the running route information to store them in the storing unit.

4. The system of claim 1, wherein the road surface profile measuring unit comprises a laser displacement sensor.

5. The system of claim 1, wherein the road surface profile measuring unit comprises a laser displacement sensor having a sampling frequency of 30 kHz.

6. A method for quantifying correlation between a road surface profile and road noise, the method comprising:
a first step of measuring a road surface profile of a road in real time during running of a vehicle and at the same time, measuring interior noise of the vehicle and running speed of the vehicle;
a second step of converting data of the road surface profile into a displacement-based signal by using the measured running speed data;
a third step of removing an error component corresponding to a distance frequency that cooperates with the road surface profile, by using the measured running speed data;
a fourth step of calculating a mean profile depth (MPD) by using the road surface profile data from which the error component is removed in the third step;
a fifth step of measuring road noise from the interior noise data; and
a sixth step of matching the MPD with the road noise to generate a correlation graph.

7. The method of claim 6, further comprising subtracting vehicle body vibration data from the road surface profile data prior to the second step.

8. The method of claim 6, further comprising removing spike noise from the road surface profile data prior to the fourth step.

9. The method of claim 6, wherein in the fifth step, the interior noise data is frequency-analyzed to measure the road noise.

10. The method of claim 6, further comprising outputting the correlation graph generated in the sixth step through a display unit to allow a user to monitor the correlation graph.

11. The method of claim 6, wherein the distance frequency is 10-1000 m⁻¹.
